(19) United States
(12) Patent Application Publication
(10) Pub. No.: US 2019/0242335 A1
(43) Pub. Date: Aug. 8, 2019

(54) AIR CLEANER CONNECTING TUBE STRUCTURE

(71) Applicant: Honda Motor Co., Ltd., Tokyo (JP)

(72) Inventors: Russell A. DIEHL, Dublin, OH (US); Zeile A. KLAISS, Powell, OH (US); Tadashi OSHIMA, Dublin, OH (US)

(21) Appl. No.: 15/888,302

(22) Filed: Feb. 5, 2018

(51) Int. Cl. F02M 35/02

(52) U.S. Cl. CPC F02M 35/0204

(57) ABSTRACT

An air cleaner of a vehicle for filtering particulate matter from air supplied through an intake includes a case with an outlet. The case surrounds the air cleaner, which further includes two connecting tubes each having a first end attached to the throttle body of the vehicle and a second end disposed in the outlet in the case of the air cleaner. A funnel is inserted into the second end of each of the connecting tubes. Clean air from the air cleaner is proved to the engine through the connecting tubes.

### TECHNICAL FIELD

The embodiments disclosed herein are related to an air cleaner for a vehicle, and more specifically to a duct system of connecting tubes connecting the air cleaner to an engine of the vehicle.

### BACKGROUND

Vehicles powered by internal combustion engines may typically include an air cleaner. The air cleaner includes a filter, an air inlet that supplies a flow of air from outside of the vehicle to the air cleaner, and an outlet that supplies a flow of filtered air to the engine. The air flows through the filter in the air cleaner to filter out particulate matter. The air cleaner includes a ducting system for directing the flow of air through the outlet to the throttle body of the engine for use as combustion air.

The air cleaner is typically located in an engine compartment of the vehicle. The volume and height of the air cleaner may impact air induction performance. A larger volume and/or a greater height of the air cleaner provides better induction pressure performance. However, the volume and/or height of the air box cleaner assembly are typically limited by packaging and space considerations. Therefore, an improved duct system is necessary to achieve maximum performance while accounting for limited space in the engine compartment.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a duct system for an air cleaner of a vehicle, the air cleaner having a case with an outlet, includes a first connecting tube, the first connecting tube having a first end and a second end disposed in the outlet of the case, and a first funnel attached to the second end of the first connecting tube positioned in the case.

According to another aspect, an air cleaner of a vehicle, the air cleaner having a case with an outlet, the case surrounding the air cleaner, includes a first connecting tube, the first connecting tube having a first end and a second end disposed in the outlet of the case, a second connecting tube, the second connecting tube having a first end and a second end disposed in the outlet of the case, a first funnel attached to the second end of the first connecting tube positioned in the case, and a second funnel attached to the second end of the second connecting tube positioned in the case.

According to yet another aspect, a vehicle includes an air cleaner, the air cleaner having a case with an outlet, the case surrounding the air cleaner, a first connecting tube, the first connecting tube having a first end and a second end disposed in the outlet of the case, a second connecting tube, the second connecting tube having a first end and a second end disposed in the outlet of the case, a first funnel attached to the second end of the first connecting tube positioned in the case, and a second funnel attached to the second end of the second connecting tube positioned in the case.

### BRIEF DESCRIPTION OF THE DRAWINGS

FIG. 1 is rear view of a portion of the rear of a motor vehicle showing the location of an air cleaner.

FIG. 2 is the rear view of the motor vehicle of FIG. 1 showing the air cleaner with a lid removed.

FIG. 3 is a perspective view of the air cleaner as illustrated in FIG. 1.

FIG. 4 is a perspective view of the air cleaner as illustrated in FIG. 2 with the lid removed to show the interior of the air cleaner.

FIG. 5 is a bottom perspective view of the air cleaner of FIG. 3.

FIG. 6 is a front view of a connecting tube and funnel of the ducting system of the air cleaner.

FIG. 7 is a rear view of the connecting tube and funnel of the ducting system of the air cleaner of FIG. 6.

FIG. 8 is a cross section of the connecting tube and funnel taken along line A-A of FIG. 6.

FIG. 9 is a cross section of the connecting tube and funnel taken along line B-B of FIG. 6.

FIG. 10 is a perspective view illustrating the connecting tubes connecting the air cleaner to a throttle body of an engine of the vehicle.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

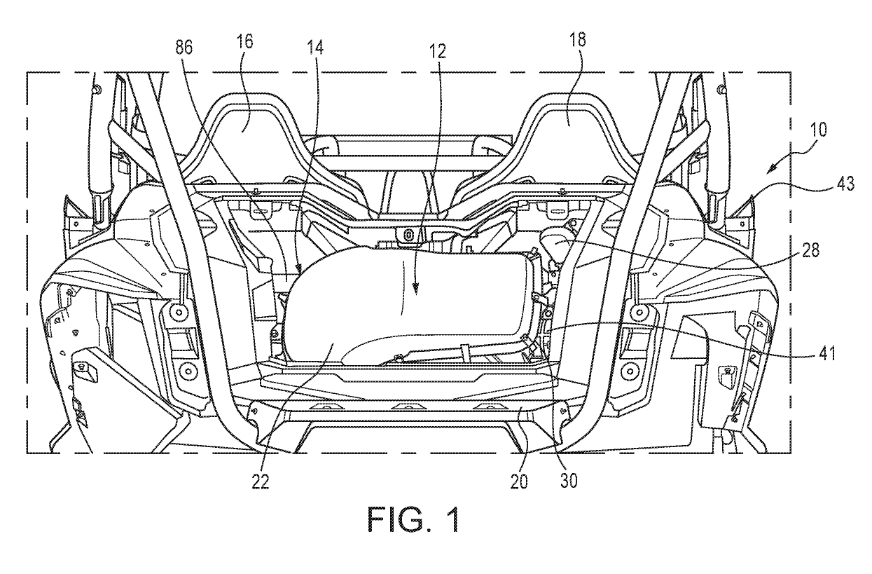

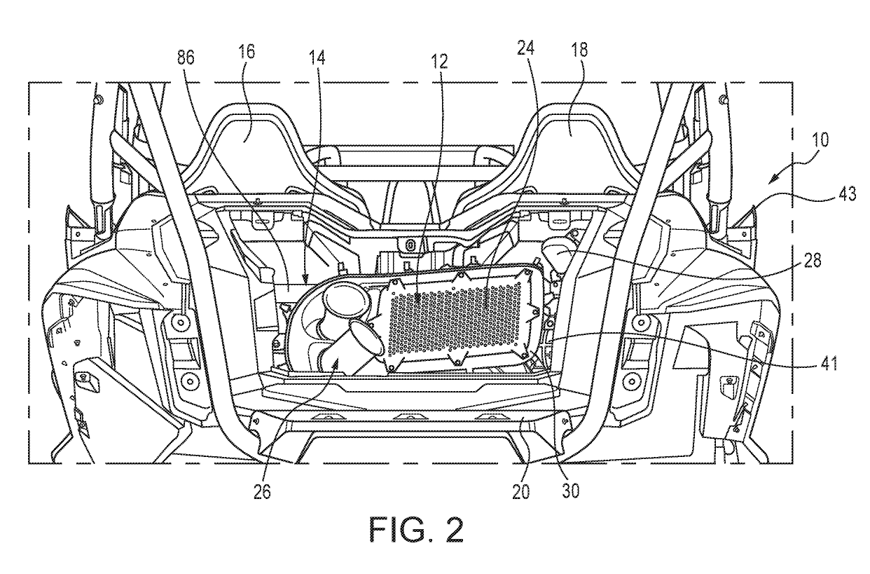

FIG. 1 is rear-view illustration of an air cleaner 12 located in the engine compartment 14 of a vehicle 10, particularly of the type known as an all-terrain vehicle (“ATV”) or a side-by-side vehicle (“S×S”). In the vehicle 10 illustrated in FIG. 1, the engine compartment 14 is located behind and below the driver seat 16 and front passenger seat 18 of the vehicle 10, and longitudinally forward of a bed 20. The air cleaner 12 may include a metal or plastic case 30 which may incorporate ducting 28 to provide cool and/or warm air from the intake 43, and with a lid 22 made of metal or plastic. FIG. 2 is a view of FIG. 1, illustrating the air cleaner 12 with the lid 22 removed. Most fuel-injected vehicles, including vehicle 10, use a pleated paper air filter 24 located inside the air cleaner 12 connected to the throttle body 80 by a duct system 26. Other vehicles that use carburetors or throttle body fuel injection typically use a cylindrical air filter, usually a few inches high and between 6 inches (150 mm) and 16 inches (410 mm) in diameter located above the carburetor or throttle body. In order to provide air to the engine, an intake 43 is provided to deliver air from outside the engine compartment 14 to the air cleaner 12, and then through the duct system 26 to the engine.

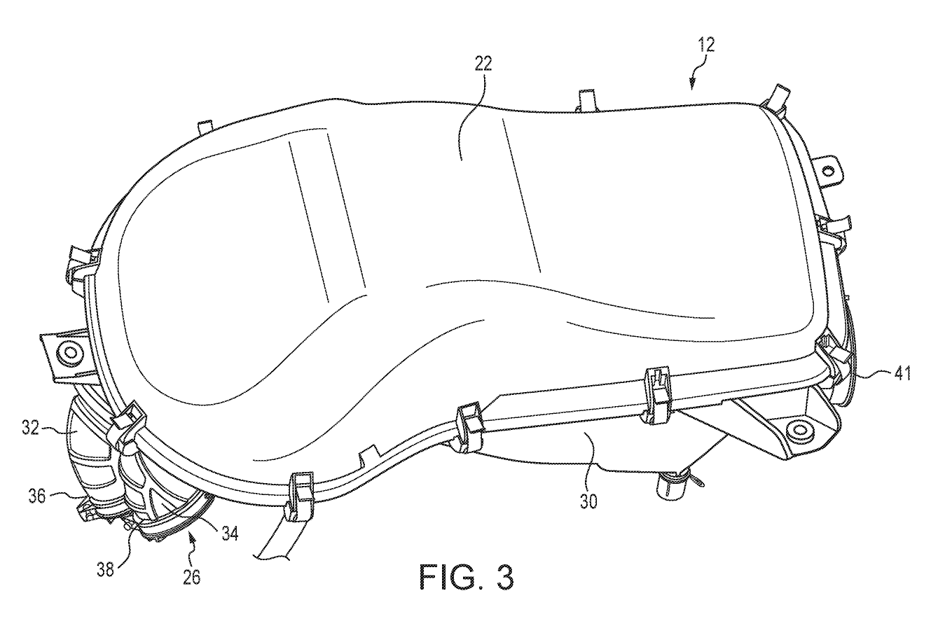

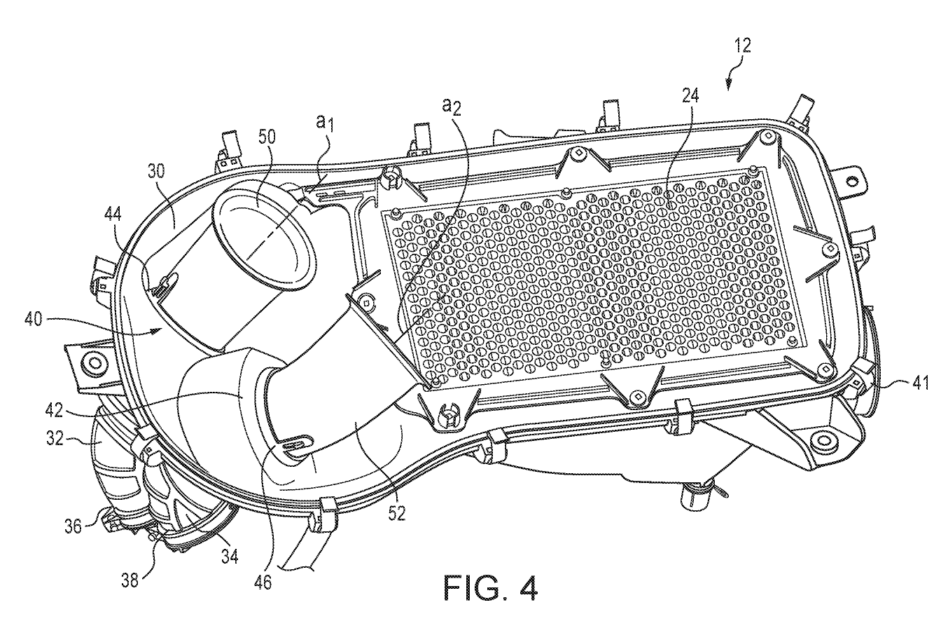

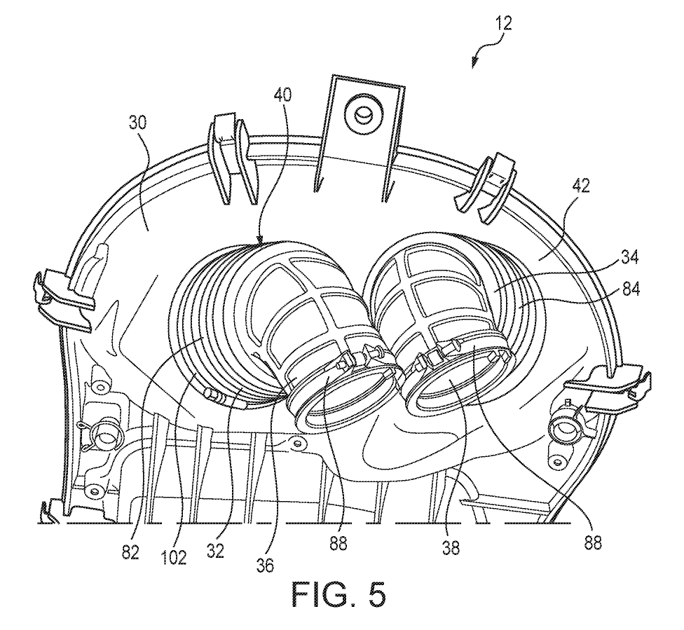

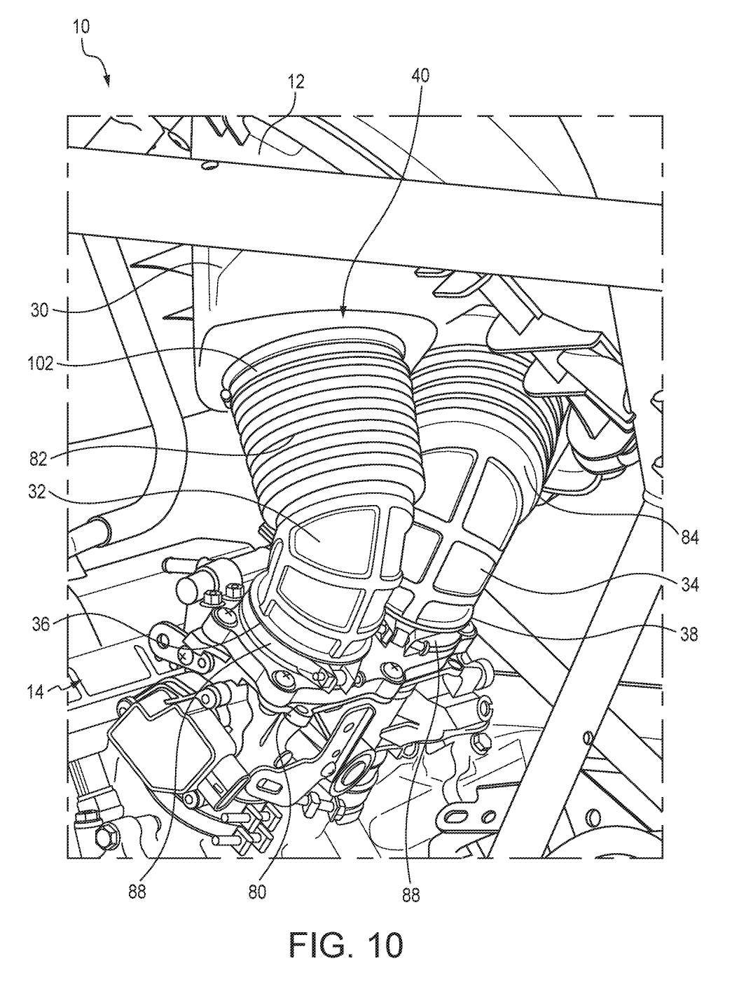

One embodiment of the air cleaner 12 is illustrated in FIGS. 3-5. FIG. 3 shows a close up exterior view of the air cleaner 12 viewed from the top of the air cleaner 12, FIG. 4 shows a close up view of the interior of the air cleaner 12 with the lid 22 removed, and FIG. 5 shows a bottom view of the air cleaner 12. The duct system 26 includes first and second connecting tubes 32, 34, each having first ends 36, 38. The first end 36 of the first connecting tube 32 connects to a throttle body 80, illustrated in FIG. 10, and the second end 44 of the first connecting tube 32 is seated in a first orifice 40 in the case 30 of the air cleaner 12. The first end 38 of the second connecting tube 34 connects to the throttle body 80, illustrated in FIG. 10, and the second end 46 of the second connecting tube 34 is seated in a second orifice 42 in the case 30 of the air cleaner 12. The first and second orifices 40, 42 collectively form an outlet of the air cleaner 12. The first and second connecting tubes 32, 34 may be constructed of a flexible, injection molded rubber or any other suitable material.

As illustrated in FIG. 4, at a distal second end 44 of the first connecting tube 32 is located a first funnel 50, and at a distal second end 46 of the second connecting tube 34 is located a second funnel 52. Each of the first and second funnels 50, 52, which may be constructed of blow-molded plastic or any other suitable materials, is seated in the second ends 44, 46 of the respective first and second connecting tubes 32, 34. The first funnel 50 includes at least one hook 54, such as an L-shaped extension as shown or any other suitable shape, extending radially outward from an outer surface 56 of the first funnel 50. The second funnel 52 includes at least one hook 54, such as L-shaped extension as shown or any other suitable shape, extending radially outward from an outer surface 58 of the second funnel 52. Each hook 54 is configured to receive a corresponding tab 60 extending upward from the second ends 44, 46 of the respective connecting tubes 32, 34.

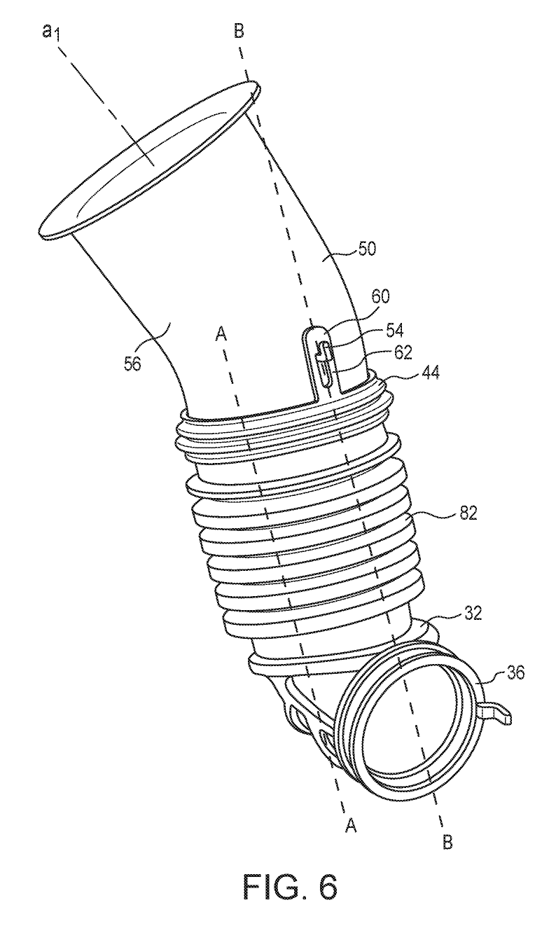

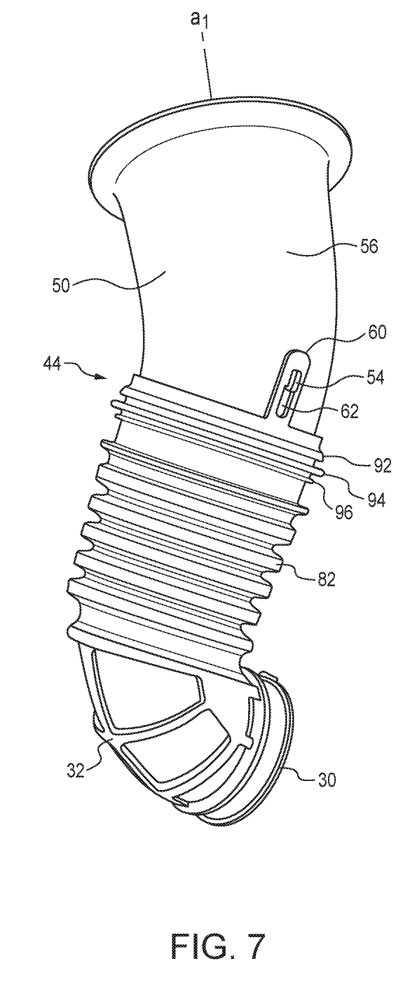

FIGS. 6-7 are close ups of the front and rear of the first connecting tube 32. While not illustrated in FIGS. 6-7, the second connecting tube 34 is identical, and the description herein applies equally in all aspects to the second connecting tube 34. Each tab 60, which is constructed of the same flexible material as the rest of the connecting tube 32, includes a slit 62 in which one of the hooks 54 may be received. Each tab 60 acts to hold the funnel 50 in place in the second end 44 of the first connecting tube 32. The funnel 50 is inserted into the first connecting tube 32 and rotated until the hooks 54 and tabs 60 are aligned. The tabs 60 may then be flexibly stretched over the hooks 54 until the hooks 54 are received in the slits 62, at which point the tabs 60 may be released to secure the funnel 50 in the first connecting tube 32. The second connecting tube 34 is assembled in an identical manner.

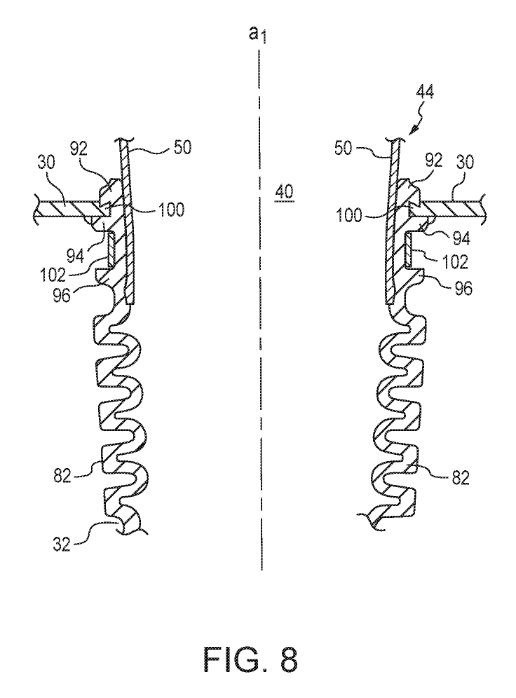

FIG. 8 is a cross section along line A-A in FIG. 6, which shows first connecting tube 32 inserted into orifice 40 in the case 30. The insertion of the second connecting tube 34 into orifice 42 in the case 30, while not shown, is identical. The second end 44 of the first connecting tube 32, on the outer surface 90 of the first connecting tube 32, includes three ribs 92, 94, 96 that surround the outer surface 90 of the first connecting tube 32. As illustrated in FIG. 8, the first two ribs 92, 94 are configured to receive the inner edge 100 of the case 30 that defines the orifice 40. As further illustrated, the last two ribs 94, 96 are configured to receive a band 102 that holds the first connecting tube 32 in frictional contact with the funnel 50. The funnel 50 further exerts force on the second end 44 of the first connecting tube 32 to keep the second end 44 in contact with the case 30, ensuring the first connecting tube 32 does not become unseated.

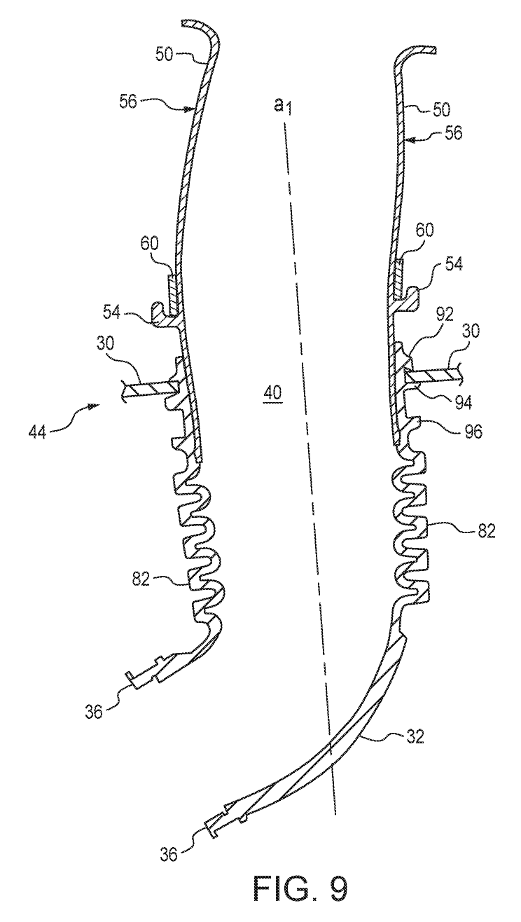

FIG. 9 is a cross section along line B-B in FIG. 6, which shows first connecting tube 32 inserted into orifice 40 in the case 30. The insertion of the second connecting tube 34 into orifice 42 in the case 30, while not shown, is identical. FIG. 9 shows in greater detail two hooks 54 extending radially outward from an outer surface 56 of the first funnel 50. Each hook 54 is engaged by a tab 60 to hold the funnel 50 in place in the second end 44 of the first connecting tube 32.

Air enters an inlet 41 of the air cleaner 12 carried from the intake 43 by the ducting 28 that is exposed to the exterior of the vehicle 10. Air passes through the air filter 24 and enters the funnels 50, 52 of the duct system 26 for passage through the outlet consisting of orifices 40, 42 to a throttle body 80 of the engine, illustrated in FIG. 10.

As further illustrated in FIG. 4, the first funnel 50 has a first central axis a₁ and the second funnel 52 has a second central axis a₂ about which the first and second funnels 50, 52, respectively, are disposed. The first central axis a₁ and second central axis a₂ are divergent, thereby ensuring each of the first and second funnels 50, 52 receives air as the size and shape of the case 30 and lid 22 may be limited due to packaging considerations. The alignment may also be used to reduce the risk of air pressure fluctuations in a particular direction or location preventing airflow through the duct system 26 to the engine, which could stall the engine.

FIG. 10 illustrates the connection of the first ends 36, 38 of the first and second connecting tubes 32, 34 to the throttle body 80 of the vehicle 10. Each of the connecting tubes 32, 34 provides filtered air from the air cleaner 12 to one of the cylinders of the engine of the vehicle 10. The first and second connecting tubes 32, 34 are connected to the throttle body 80 by circular clamps 88 or any other suitable method. Additionally, FIGS. 6-10 illustrate the bellows 82, 84 that form a central portion of the respective first and second connecting tubes 32, 34. The air cleaner 12 is rigidly mounted to the frame 86 of the vehicle 10, while the engine, which includes the throttle body 80, is mounted on rubber engine mounts to absorb engine vibrations. The bellows 82, 84 provide flexibility in the movement of the first and second connecting tubes 32, 34 as the engine and throttle body 80 may flexibly move relative to the rigidly mounted air cleaner 12.

While the embodiments illustrated in the FIGS. 3-8 show first and second connecting tubes 32, 34, additional embodiments may feature either one connecting tube in the event a single cylinder engine is applied to the vehicle 10, or more that two connecting tubes in the event more than two cylinders are applied. Further, if an intake manifold were to be applied to the engine, a single connecting tube may be sufficient.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A duct system for an air cleaner of a vehicle, the air cleaner having a case with an outlet, comprising:
a first connecting tube, the first connecting tube having a first end and a second end disposed in the outlet of the case; and
a first funnel attached to the second end of the first connecting tube positioned in the case.

2. The duct system of claim 1 further comprising:
a first hook extending radially outward from an outer surface of the first funnel;
a first tab extending from the second end of the first connecting tube, the first tab having an opening for receiving the first hook.

3. The duct system of claim 2 further comprising:
a second hook extending radially outward from the outer surface of the first funnel;
a second tab extending from the second end of the first connecting tube, the second tab having an opening for receiving the second hook.

4. The duct system of claim 3 further comprising:
a second connecting tube, the second connecting tube having a first end and a second end disposed in the outlet of the case; and
a second funnel attached to the second end of the second connecting tube positioned in the case.

5. The duct system of claim 4 further comprising:
a first hook extending radially outward from an outer surface of the second funnel;
a first tab extending from the second end of the second connecting tube, the first tab having an opening for receiving the first hook.

6. The duct system of claim 5 further comprising:
a second hook extending radially outward from the outer surface of the second funnel;
a second tab extending from the second end of the second connecting tube, the second tab having an opening for receiving the second hook.

7. The duct system of claim 6 wherein the first funnel and the second funnel are comprised of blow-molded plastic.

8. The duct system of claim 6 wherein the first connecting tube and the second connecting tube are comprised of injection-molded rubber

9. The duct system of claim 8 wherein the first connecting tube further comprises a bellows for allowing the first connecting tube to flexibly move relative to the case, and the second connecting tube further comprises a bellows for allowing the second connecting tube to flexibly move relative to the case.

10. The duct system of claim 4 wherein the first funnel has a first central axis and the second funnel has a second central axis and wherein the first central axis and second central axis are divergent.

11. An air cleaner of a vehicle, the air cleaner having a case with an outlet, the case surrounding the air cleaner, comprising:
a first connecting tube, the first connecting tube having a first end and a second end disposed in the outlet of the case;
a second connecting tube, the second connecting tube having a first end and a second end disposed in the outlet of the case;
a first funnel attached to the second end of the first connecting tube positioned in the case; and
a second funnel attached to the second end of the second connecting tube positioned in the case.

12. The air cleaner of claim 11 wherein the first funnel has a first central axis and the second funnel has a second central axis and wherein the first central axis and the second central axis are divergent.

13. The air cleaner of claim 12 further comprising:
at least one hook extending radially outward from an outer surface of the first funnel; and
at least one hook extending radially outward from an outer surface of the second funnel.

14. The air cleaner of claim 13 further comprising:
at least one tab extending from the second end of the first connecting tube, the at least one tab having an opening for receiving the at least one hook extending from the outer surface of the first funnel; and
at least one tab extending from the second end of the second connecting tube, the at least one tab having an opening for receiving the at least hook extending from the outer surface of the second funnel.

15. The air cleaner of claim 14 wherein the first connecting tube further comprises a bellows for allowing the first connecting tube to flexibly move relative to the case, and the second connecting tube further comprises a bellows for allowing the second connecting tube to flexibly move relative to the case.

16. The air cleaner of claim 15 wherein the first funnel and second funnel are comprised of blow-molded plastic.

17. The air cleaner of claim 16 wherein the first connecting tube and second connecting tube are comprised of injection-molded rubber.

18. A vehicle, comprising:
an air cleaner, the air cleaner having a case with an outlet, the case surrounding the air cleaner;
a first connecting tube, the first connecting tube having a first end and a second end disposed in the outlet of the case;
a second connecting tube, the second connecting tube having a first end and a second end disposed in the outlet of the case;
a first funnel attached to the second end of the first connecting tube positioned in the case; and
a second funnel attached to the second end of the second connecting tube positioned in the case.

19. The vehicle of claim 18 further comprising:
at least one hook extending radially outward from an outer surface of the first funnel;
at least one hook extending radially outward from an outer surface of the second funnel;
at least one tab extending from the second end of the first connecting tube, the at least one tab having an opening for receiving the at least one hook extending from the outer surface of the first funnel; and
at least one tab extending from the second end of the second connecting tube, the at least one tab having an opening for receiving the at least one hook extending from the outer surface of the second funnel.

20. The vehicle of claim 19 wherein the first funnel has a first central axis and the second funnel has a second central axis and wherein the first central axis and the second central axis are divergent.
